(19) United States
(12) Patent Application Publication
(10) Pub. No.: US 2006/0053049 A1
(43) Pub. Date: Mar. 9, 2006

(54) Process for delivering a menu of media and computer options potentially at no cost to consumers in exchange for viewing interactive advertisements

(76) Inventor: Brian Ardle Nolan, Lilburn, GA (US)

Correspondence Address: Brian Ardle Nolan, 760 Ryans Run Court, Lilburn, GA, 30047, US

(21) Appl. No.: 10/934,982

(22) Filed: Sep. 4, 2004

(51) Int. Cl. G06Q 30/00; H04N 7/10

(52) U.S. Cl. 705/14; 725/32

(57) ABSTRACT

A structure for creating a facilitator organization to deliver a menu of media and Internet options potentially at no cost to consumers in exchange for viewing interactive advertisements with the steps of: creating the facilitator organization, by which a single entity is created offering the media and Internet services via any and all available means to the consumer, offering the commercial businesses the advertising services, offering the media and the Internet services to deliver the services to the consumer, offering the interactive advertising to the consumers, collecting and distributing revenue by the advertising viewed by the consumers on the Internet services and the television, by which the data is collected and analyzed, by which the advertiser is satisfied that the advertising has reached the demographic and numerical population that the advertiser has contracted with the facilitator for.

A process for delivering a menu of media and computer options potentially at no cost to consumers in exchange for viewing interactive advertisements.

### CROSS REFERENCE TO RELATED APPLICATIONS

Not Applicable

### STATEMENT REGARDING FEDERALLY SPONSORED RESEARCH OR DEVELOPMENT

Not Applicable

Description of Attached Appendix

Not Applicable

### BACKGROUND OF THE INVENTION

This invention relates generally to the field of a business method and more specifically to a process for delivering a menu of media and computer options potentially at no cost to consumers in exchange for viewing interactive advertisements. Delivering remote produced entertainment to multiple homes began with the introduction of the radio. This was followed up by the television. Both of these marvels were made available because the government made airwave spectrum available to the industries and commercial businesses paid the industries to run advertising that promoted their goods or services to the people receiving the entertainment. The fact that the public had no financial outlay beyond the cost of the receiver caused the industries to flourish. Recent decades have brought many innovations to the home entertainment industry. These additional advances however come with financial cost to the public. There are myriad companies that compete with each other to garner the publics interest in their segment of the industry and solicit the publics available disposable income.

The most popular element in home entertainment is the television. Delivery to the home has expanded from its original means through the airwaves for free. Now it is available via satellite, over installed cable connections, and through the use of broadband delivery. These are offered to the public at a cost for the service. These same cost-based delivery systems are utilized by Internet service providers who give access to the worldwide web. Radio reception in the home and in the car is most commonly provided free to the consumer through the airwaves however satellite delivery is becoming popular.

The companies that have created the fee-based alternatives or auxiliaries to the free airwave delivery television programming have added significant options to the market. They offer a variety of channels that were not feasible with the conventional broadcast medium. They offer pay-per-view programming that can be accessed using a remote control device that is used to choose various selections of both the program spectrum and on the television receiver.

Tivo has manufactured a device that allows the customer to do their own programming among all the wide-range of options. VCR and DVD technologies can make any programming available to the consumer through purchase or rental of the recorded audio/visual art.

The personal computer is the conventional means to deliver the Internet. The Internet opens the computer to the Worldwide Web. The Web connects users to all other users throughout the world. It also connects them to sites that offer information, goods and services. Many of these sites present a cost to a person using them that is above and beyond the cost of the access. Some of the costs are augmented by advertising that is made available by the Internet Provider or the business that operates a site. Popular services over the Internet include the downloading of music, Internet banking, Internet gaming, live web camera, and online shopping.

Telephone lines have been the traditional way to receive telephonic communication. Cellular telephone reception has been delivered through both analog and digital wave production. There have always been costs for the usage of these technologies. The options for the use of these technologies continue to expand at rapid rates.

As the choices for in-home entertainment to the consumer have continued to develop, the avenues for the advertiser have expanded. The business can put their message in front of the customer in previously unthought of ways.

One new means for advertising over the Internet is to offer an incentive to the consumer to view the ad message. They are given a coupon that can be redeemed potentially for in-kind goods and services.

A pay-per-view incentive offers a free access in return for several paid accesses.

The prior technologies are deficient primarily because there are so many entities competing for the same limited financial resources and the cost to the consumer.

The advertiser-funded radio stations are numerous and have to compete with each other to attract listenership. That is the basis on which they are able to convince advertisers to use them and the basis on which they present their scale of ad costs to businesses. They not only compete with each other but all the other various means to put an advertising message over to the public. Competition for the correct programming and market share is also the challenge of the advertiser-funded television stations. They have to produce product that will appeal to the greatest number in the demographic that the potential advertiser wishes to reach. This competition can cause success to be elusive and can restrain profit.

The chief deficiency in subscriber television and radio and any subsequent services is the cost to the consumer. Each new choice presents an additional drain on the finances of the customer. The customer must always consider their cost as they decide what menu options that they will add. Internet access and subsequent site availability have always been subscriber-based and present the same disincentive. All telephone service is provided to the customer through some form of subscriber contract.

The capitalist system has competition as an inherent strength and deficiency. The drawback is that it is difficult for any business to get their message effectively across to all consumers. This is true for the numbers of programming service providers and the businesses that advertise using these services.

There is not a single entity for the advertiser to go to. They must choose a multitude of advertising venues to reach the greatest number of people and at great cost or the advertiser must be satisfied with minimal results. The successful advertiser must saturate the marketplace by casting a wide net in hopes of reaching a specific demographic that would best suit their product or service.

The consumer is subjected to greater numbers of ad messages as the advertisers struggle to find the best exposure. The consumer must weigh all the different offers from the various competing service providers to make sure they get the best value for their dollars.

The method that offers free access as an incentive for the purchase of multiple pay-per-view products still has the deficiency of the initial cost and the difficulty in attracting the consumer to the offer in the first place. The steps include that: they have to be found, the product has to have monetary incentive to the customer, and the incentive has to represent satisfactory compensation to the customer for the cost outlay. It has an incentive that is limited and the opportunity to redeem it is limited.

Receiving credit for viewing advertising over the Internet can present some of the same problems already discussed. There is financial pay out for the personal computer and the access to the Internet. The site needs to attract the attention of the public among numerous other distracting messages. It lacks the ability to attract a large audience. The incentive must represent a compensating value to the viewer for their time. A separate incentive would be required if done on separate sites or possibly by different advertisers. The advertiser couldn't always choose the demographic and projected return on their cost. The advertiser must consider the cost and limited exposure as opposed to other possible choices. The customer would be asked to take the added step of redeeming the incentive that could represent another inconvenience.

### BRIEF SUMMARY OF THE INVENTION

The primary object of the invention is to provide the consumer a comprehensive package of media and Internet services.

Another object of the invention is to provide the consumer a comprehensive package of media and Internet services potentially at no out of pocket cost to the consumer.

Another object of the invention is to allow consumers the opportunity to receive media and Internet services at no cost in exchange for viewing commercial advertisement.

A further object of the invention is to provide consumers the flexibility to view commercials at their discretion.

Yet another object of the invention is to allow the consumer to receive products and services regardless of time schedule.

Still yet another object of the invention is to allow the consumer to receive products and services regardless of economic circumstance.

Another object of the invention is to provide the consumer the widest possible options in the media and Internet service arena.

Another object of the invention is to allow the consumer to specify the media and Internet service options that interest them.

A further object of the invention is to give the consumer a one stop shopping opportunity for all their media and Internet services as well as future options.

Yet another object of the invention is to enable the media provider to reach the greatest number of consumers.

Still yet another object of the invention is to remove the disincentive of a subscriber fee to the consumer in choosing a media provider and its products and services.

Another object of the invention is to enable the Internet service provider to reach the greatest number of consumers.

Another object of the invention is to remove the disincentive of a subscriber fee to the consumer in choosing an Internet service provider and its products and services.

A further object of the invention is to broaden access to the Internet through reception on a television screen.

Yet another object of the invention is to provide the advertiser a guaranteed viewership of their commercials.

Still yet another object of the invention is to enable the advertiser to choose specific demographics.

Another object of the invention is to eliminate the need for the advertiser to choose the correct programming to schedule their commercials.

Another object of the invention is to eliminate the need for the advertiser to target a particular time slot.

A further object of the invention is to produce an incentive that reduces negative attitudes towards commercials.

Yet another object of the invention is to provide an incentive that insures the consumers undivided attention.

Still yet another object of the invention is to eliminate the need to interrupt programming and maximize the consumers attention.

Another object of the invention is to use interactive modalities via telephonic and Internet connections to insure consumers understanding of the advertising message.

Another object of the invention is to allow the advertiser feed back that can assist them in better construction of the advertising content.

A further object of the invention is to allow the advertiser the ability to present ancillary incentives in the form of coupons, etc.

Yet another object of the invention is to allow content providers to promote their programming.

Still yet another object of the invention is to remove the disincentive of a subscriber fee to the consumer in choosing programming content.

Another object of the invention is to give the content programmers the widest possible revenue base.

Another object of the invention is to disconnect the programming content from the generation of advertising revenue.

Yet another object of the invention is eliminate the requirement to redeem a credit to receive service.

Still yet another object of the invention is to provide service first and then require the advertising viewing.

Another object of the invention is to have the advertiser know exactly who is getting their message.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a means for creating a facilitator organization for delivering a menu of media and computer options potentially at no cost to consumers in exchange for viewing interactive advertisements comprising the steps of: creating said facilitator organization, offering a single entity for media and Internet services to the consumer, offering a single entity to the commercial advertiser to contract for advertising services, offering a single entity to the media and the Internet services to deliver said services to the consumer, offering the interactive advertising to the consumers, collecting and distributing revenue by the advertising viewed on the Internet services and the television, by which the facilitator offers the media and the Internet services to the consumer potentially at no financial cost in exchange for viewing interactive advertising via the television and the Internet, by which the facilitator will ask questions regarding the advertising on behalf of the advertiser, by which the facilitator will operate a series of Internet sites that will provide a selection of advertising messages and related interactive questions, by which the facilitator will contract with program providers to secure dial settings that will show a selection of advertising messages and related interactive questions, by which the facilitator will receive data via the Internet or telephone connection, by which the facilitator will provide the consumer with a wireless Internet keyboard, by which the facilitator will provide the consumer with a remote control that operates interactively with a program providers receiver.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic block diagram of the basic component participants.

FIG. 2 is a schematic block diagram of an alternate embodiment of the invention if the Facilitator also acts as the Provider.

FIG. 3 is a schematic block diagram of the component participants and the interactions that constitute the basic means for the invention.

FIG. 4 is a schematic block diagram of an alternate embodiment of the invention if the Programming and Internet Providers accept the Facilitator to administer to their Customers.

FIG. 5 is a schematic block diagram of an alternate embodiment of the invention if the Customer has an existing relationship with the Programming and Internet Providers.

FIG. 6 is a schematic block diagram of an alternate embodiment of the invention if the Facilitator is also the Programming Provider.

FIG. 7 is a schematic block diagram of an alternate embodiment of the invention if the Facilitator is also the Internet Provider.

FIG. 8 is a schematic block diagram of an alternate embodiment of the invention if the Customer wishes Optional Services.

FIG. 9 is a schematic block diagram of an alternate embodiment of the invention if the Facilitator provides Optional Services.

FIG. 10 is a schematic block diagram of an alternate embodiment of the invention if the Customer has an existing relationship with Optional Service Providers.

FIG. 11 is a schematic block diagram of an alternate embodiment of the invention for retrieving data through contact with the Customer.

FIG. 12 is a flow chart of the operations that comprise the method for conducting business with the Advertiser.

FIG. 13 is a flow chart of the operations that comprise the method for conducting business with the Customer.

FIG. 14 is a flow chart of the operations that comprise the method for conducting business with the Providers.

FIG. 15 is a flow chart of the operations that comprise an alternate embodiment of the method for conducting business as the Facilitator.

FIG. 16 is a flow chart of the operations that comprise an alternate embodiment of the method for conducting business when the Customer has existing service with the Program Provider.

FIG. 17 is a flow chart of the operations that comprise the method for conducting business with the Data Patron.

FIG. 18 is a flow chart of the operations that comprise the method.

FIG. 19 is a flow chart of the operations that comprise an alternate embodiment of the method if the Facilitator is also the Provider.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

1. Functional Overview

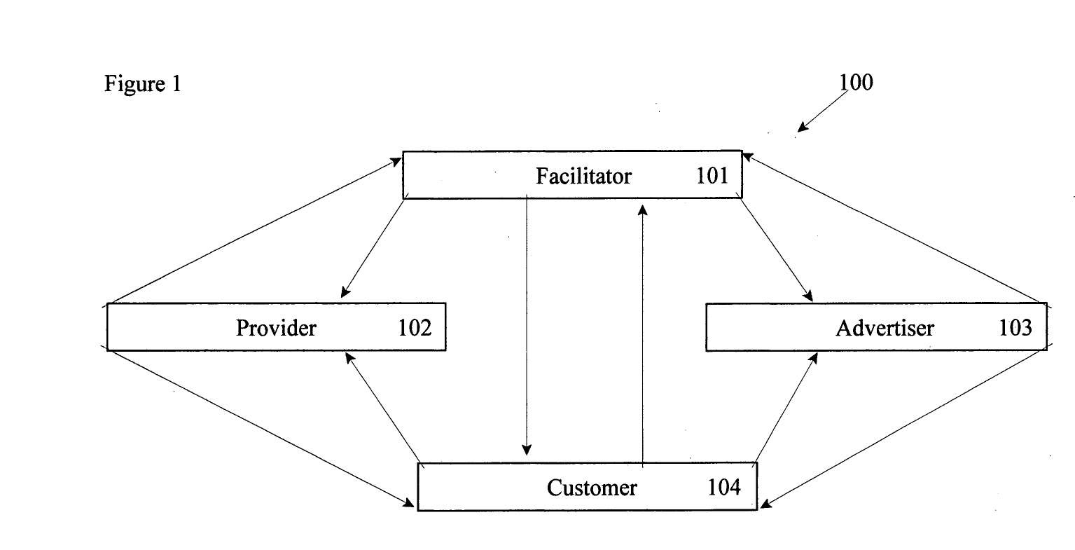

FIG. 1 is a schematic block diagram 100 that illustrates an approach for setting up an enterprise that contracts to offer media to customers according to various embodiments described herein. As used herein, the term “media” refers to any commercial goods that relates to the transmitting of entertainment or of information. Examples of this include, without limitation, television service that can be transmitted using airwave spectrum, satellite, cable, and broadband. Further examples are the Internet access to the Worldwide Web, Internet usage of streaming video, Internet usage for downloading music, Internet banking and gaming, land and cellular telephonic communication using receivers, pay-per-view programming, and satellite radio. In general, the media content and the delivery of the media need not change. This invention deviates from previous art in that it offers the same product with the intervention of a Facilitator 101 who acts as a middleman between the contracting parties meaning the Provider 102 and the Customer 104. It is noted that in accordance with FIG. 1 there is the addition of the Advertiser 103 to the diagram. The inclusion of the Advertiser 103 makes possible the opportunity for the Facilitator 101 to charge the Advertiser 103 for advertising commercials sent over some portion of the media. The Customer 104 views the advertising and is given credit. The Facilitator 101 applies that credit to the cost of the media product that the Customer 104 chooses. The Facilitator pays the Provider 102 for the service. Hence, Customers 104 are not constrained by financial factors in selecting their media options. Therefore, the Providers 102 have a greater opportunity to contract with subscribers and Advertisers 103 have a greater opportunity to convey their message to their desired audience.

According to one embodiment, the Facilitator 101 contracts with the other parties, meaning the Provider 102, the Advertiser 103 and the Customer 104, individually to establish relationships that are a benefit to all. The Facilitator 101 arranges for the Customer 104 to receive the services of the Provider 102, potentially, at not out of pocket cost provided they view a prescribed amount of advertising delivered by the Provider 102 on behalf of the Advertiser 103 in an interactive format. More specifically but without limitation, (101>102) the Facilitator 101 offers to the Provider 102 a population of Customers 104. The Facilitator 101 pays for the services on behalf of the Customer 104. The Facilitator 101 supplies the Provider 102 with the advertising content, the software programming needed to collect the data, and the information that needs to be collected by the Provider 102 and returned to the Facilitator 101.

Furthermore, according to an embodiment, (102>101) the Provider 102 processes the service order initiated by the Facilitator 101 on behalf of the Customer 104. The Provider 102 manages the contract with the Facilitator 101 for the service provided to the Customer 104. The Provider 102 installs and maintains the equipment for the Customer 104. The Provider 102 makes available the venue on the equipment, not limited to, via the airwaves, satellite, broadband, or cable and Internet connections. The Provider 102 uses the software supplied by the Facilitator 101 to transmit and collect data. The Provider 102 transmits the advertising content as designated by the Facilitator 101. The Provider 102 gives the accumulated data to the Facilitator 101. The Provider 102 will make available channel spectrum space or Internet sites. The Facilitator 101 will give the Provider 102 the list of customers that are to receive their particular product or service. The Provider 102 will be instructed as to which channels or sites should run which commercials. The Provider 102 that will be running the commercial will receive instructions form the Facilitator 101 as to what commercial viewing will be needed from each Customer 104.

Moreover, according to an embodiment, (101>103) the Facilitator 101 offers a population of potential Customers 104 to the Advertiser 103 at a price determined by the number and demographics of the Customer 104 profile that they wish to view their message. The Facilitator 101 receives the capture information from the Provider 102 that summarizes the information pertinent to the Customers 104 reached, the results of the interactive communication, and other relevant data. (103>101) The Facilitator 101 processes an order from the Advertiser 103 based on the number of Customers 104 that they want to reach and the demographic specifications that they want to target. The Advertiser 103 provides The Facilitator with the advertising that they want to run along with the interactive message that they want to deliver. The Advertiser 103 may elect to have the Facilitator 101 produce the advertising and interactive message. The Advertiser 103 will pay the Facilitator 101 for the achieved results based on the contract price.

According to an embodiment, (101>104) the Facilitator 101 will solicited for Customers 104 who wish to pursue a service that will provide them with a variety of products and services potentially at no charge to them provided that they meet an interactive advertising viewership requirement. The Facilitator 101 will collect the interactive Customer 104 data and verify the Customer 104 viewership. The Facilitator will collect demographic data in order to make a profile to provide to the Advertiser 103. (104>101) The Customer 104 will contract with the Facilitator 101 to provide selections of services from a menu. The Customer 104 will agree to pay the Facilitator 101 in currency for the product should they not meet the criteria of interactive advertising viewership The Customer 104 will agree to watch a designated number of minutes of interactive advertising that will be based on the number of menu items that they select. They will answer the interactive questions and provide other information requested. The Customer 104 will give the required demographic information to the Facilitator 101 that is deemed necessary to form a demographic profile to give to the Advertiser 103 as part of a general population.

Continuing with the description of an embodiment, (102>104) the Provider 102 delivers the services that the Facilitator 101 has contracted for on behalf of the Customer 104. The Provider 102 enables the means for the interactive facet of the advertising obligation. The Provider 102 also delivers the advertising messages to the Customer 104. Any installation of equipment or means of delivering the services is the responsibility of the Provider 102. (104>102) The Customer 104 responds to the interactive presentation of the advertising message. This enables the Provider 102 to complete its obligation to the Facilitator 101 and receive compensation.

Finally in an embodiment, (103>104) the Advertiser 103 is indirectly responsible for the programs and service enjoyed by the Customer 104. They supply the Facilitator 101 and the Provider 102 with the message and interactive requirements that allow them to be compensated for delivery of the information contained in the message. (104>103) The Customer 104 allows themselves to be informed about products and services by the Advertiser 103. They confirm an understanding of the message, product or service through the Providers 102 and the Facilitator 101 so that the Advertiser 103 can compensate them for the services.

2. Alternate Functional Overview

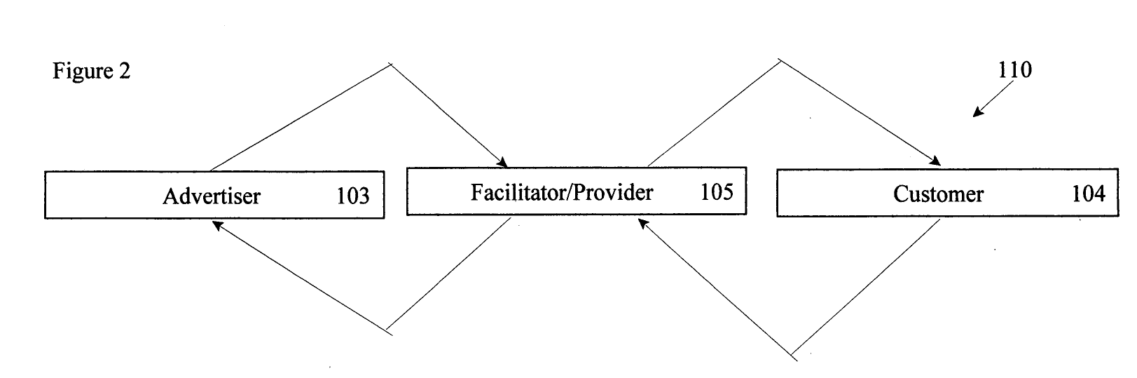

FIG. 2 is a schematic block diagram 110 that illustrates an approach for setting up an enterprise that contracts to offer media to customers according to an alternate embodiment described herein. In general, the Facilitator 101 is the Provider 102 of one or more of the items offered to the Customer 104 from the possible menu. This can happen but is not limited to a contractual alliance between the inventor and a Provider 102 or the inventor can establish himself in that role by combining the structures of Facilitator 101 and Provider 102. The Facilitator/Provider 105 establishes the means to deliver the media content to the Customer 104. They also directly deliver the advertising message and collect the feedback from the Customer 104. In all other ways, the embodiment is similar to the previously described embodiment.

(105>103) According to one embodiment, the Facilitator/Provider 105 gives information retrieved from interactive advertising viewership by the Customer 104 along with a summary of demographic data. No specific Customer 104 information would be revealed except at the Customer's 104 request. The Advertiser 103 would produce a commercial message along with an information request to satisfy the interactive element of the ad. (103>105) The Advertiser 103 would specify to the Facilitator/Provider 105 the demographic representation that they wanted to reach and the total number of Customer 104 households they wanted to receive the message. The Advertiser 103 would compensate the Facilitator/Provider 105 for the results based on an agreed upon price. The price would vary by the demographics sought, the nature of the interactive data that is received, and the amount of time viewed.

(105>104) Furthermore, according to an embodiment, the Facilitator/Provider 105 would offer services as the Provider 102 to the Customer 104. The Facilitator/Provider 105 would contract for and package the media elements requested by the Customer 104. The Facilitator/Provider 105 would deliver and collect the message and interactive data supplied by the Advertiser 103. (104>105) The Customer 104 would contract with the Facilitator/Provider 105 for the media services that they wished to receive. They would agree to pay a market price. In lieu of the monetary price, the Customer 104 would agree to view a specified amount of interactive advertising. The Customer 104 would input the information requested by the interactive message to be collected by the Facilitator/Provider 105. The Customer 104 would give the Facilitator/Provider 105 demographic data on a confidential basis to supply the Advertiser 103 with a choice of recipients based on their need.

3. Definitions

The Facilitator refers to the inventor and/or an authorized agent who employees the use of the invention. Its function is to coordinate the relationships between the other parties in various embodiments of the invention. The Facilitator/Provider is the inventor and/or an authorized agent in an alternate embodiment of the invention where the Facilitator Provider performs a dual role of the Facilitator and either the Television Programming Provider or the Internet Provider or both. The Advertiser is a general description of any, not limited to, company or individual who seeks the benefit of making their product or service known to the public. The Customer is any member of the public at-large who has the need or desire for the services available through the Facilitator and to who the Advertiser would wish to reach with their message. The Provider consists of but is not limited to those who provide television programming or Internet access. The Television Programming Provider is an entity that belongs to the Provider category and typically offers television programs to the public through multichannel services via but not limited to cable, satellite, broadband or the public airwaves. Programming refers to the various channels that offer content directly to the public or through Television Programming Providers via but not limited to cable, satellite, broadband or the public airwaves. The Internet Provider is an agent who packages and delivers Internet service and access to the public. The Internet is a general term meant to apply to information distributed through what is refereed to as the worldwide web. The Optional Service Provider refers to a multitude of ancillary media services that would be offered to the customer. They would include but not be limited to streaming video, Internet banking, Internet gaming, Tivo, land and cellular phone service, satellite radio, and Home Shopping. The Data Patron is an entity that does not want to sell items directly to the consumer. The Data Patron is interested in information. They deal primarily with, but are not limited to, survey and polling information. The Data Patron can come from a multitude of backgrounds and disciplines. Examples of this would be, but are not limited to, the political arena, the television industry, academia, and the government. The data sought would be, but is not limited to, opinions on political candidates, political positions, favorite television programs, independent and government studies, and the favorability of commercial products.

4. A Typical Relationship Structure

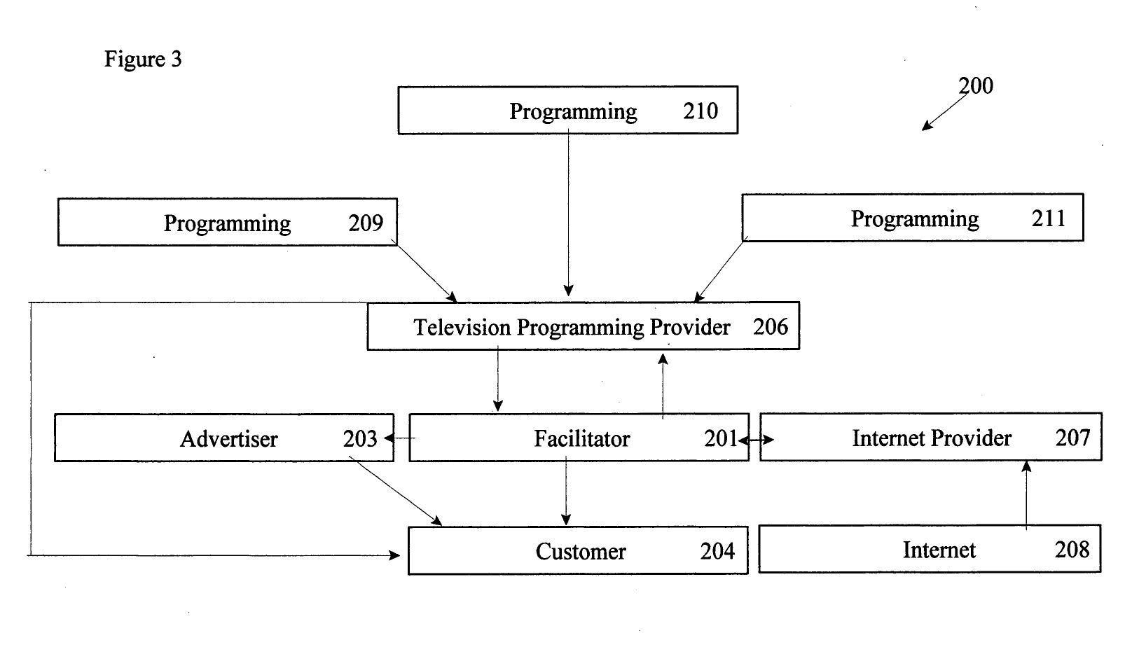

FIG. 3 is a schematic block diagram 200 that illustrates an approach for setting up an enterprise that contracts to offer media to customers according to one embodiment described herein. The diagram 200 reveals several, but not limited to, relationships that may be involved in an embodiment of the invention. The Facilitator 201 coordinates the services that would allow the plan to be viable in a variety of circumstances. It would consist of a media package that would satisfy the needs of the Customer 204 and the Advertiser 203. The Facilitator 201 would arrange with the Television Programming Providers 206 specific to the service that they supply to a geographic area. Their selection would depend on the coverage that the Television Programming Provider 206 could offer as well as the Programming 209, 210, 211 that they were able to carry for the entertainment of the Customer 204. The Facilitator 201 would solicit Advertisers 203 that would be interested in exposure to the Customer 204 base that was serviced by the Facilitator 201. At the same time, the Facilitator 201 would solicit Customer 204 with the offer of potentially free Television Programming 209, 210, 211 and Internet 208 service if they meet the required viewing of interactive advertising. They Facilitator 201 would establish a relationship with one ore more Internet Providers 207 on a national or regional basis which would them be offered to the Customer 204 as part of the package discussed previously.

(201>203) In an embodiment, the Facilitator 201 offers a population of potential Customers 204 to the Advertiser 203 at a price determined by the number and demographics of the Customer 204 profile that they wish to reach. The Facilitator 201 captures information as to which Customers 204 were successfully reached, the results of the interactive communication and any other aspect of the retrieved data. (201>203) The Facilitator 201 receives an order from the Advertiser 203 based on the number of Customer 204 that they want to reach and the demographic specifications they want to target. The Advertiser 203 supplies the the Facilitator 210 with the advertising content that they want to run along with the interactive message that they want a response for. The Advertiser 203 may elect to have the Facilitator 210 produce the advertising content and/or the interactive message. The Advertiser 203 will pay the Facilitator 201 for the achieved results based on the contracted price.

Furthermore, according to an embodiment, (201>204) the Facilitator 201 will solicit for Customer 204 who wish to pursue a service that will avail them with a variety of products and services potentially at no charge to them provided that they meet an interactive viewership requirement. The Facilitator 201 will collect demographic information from the Customer 204 in order to construct a profile to offer to the Advertiser 203. (204>201) The Customer 204 will contract with the Facilitator 201 to provide selections of services from a menu. An embodiment would offer the basic services comprised of a Television Programming Provider 206 and an Internet Provider 207. The Customer 204 would agree to pay the Facilitator 201 in currency for the media product should they not meet the criteria of the interactive viewership. The Customer 204 would agree to watch a designated number of minutes of interactive advertising that will be based on the number of menu options that they select and the number of credits offered for watching a specific advertisement piece. In an embodiment this would involve but would not be limited to Television Programming 209, 210, 211 and Internet 208. The Customer 204 will answer the interactive questions or provide other information requested using a television remote control or Personal Computer key pad in response to prompts on the screens. The Customer 204 will give the required demographic information to the Facilitator 201 that is deemed necessary by the latter to form a demographic profile to advance to the Advertiser 203 as part of a general population of potential targets for the message.

Continuing an embodiment, (201>207) the Facilitator 201 would arrange with the Internet Provider 207 to service a list of Customers 204. The Facilitator 201 will collect funds from the Advertisers 203 who have had their interactive message viewed by the Customers 204 and pay the Internet Provider 207 for that service. The Facilitator 201 may but will not be limited to the use of the Internet 208 in certain circumstances as an alternative means for the viewing and responding to the interactive advertising method. In that case, the Facilitator 201 will arrange for web sites for that purpose with the Internet Provider 207. (207>201) The Internet Provider 207 will install and maintain Internet 208 service in homes and businesses that will allow it to be viewed over but not limited to a personal computer or over the television and operated with a cordless key pad. (208>207) The Internet Provider 207 will package and present to the Customer 204 access and a format for interacting with the Worldwide Web through an Internet 208 system.

In another feature of an embodiment, the Facilitator 201 would contact with one or more companies that are in the business of providing the television programming of several networks here described but not limited to the generic description of Programming 209, 210, 211. The number that are offered by the Television Programming Provider 206 will be determined by their availability to the subscribing Customer 204 and the attractiveness of the financial arrangement. (210>206) The Facilitator 201 will give the Television Program Provider 206 the advertising messages to be run, the times that they will be run and the channels on which to run them. The Facilitator 201 will compensate the Television Program Provider 206 for the service on behalf of the Customer 204, for the interactive data that is retrieved, and for the channels on which the messages are run. (206>201) The Television Programming Provider 206 will deliver their services to a list of clients provided to them by the Facilitator 201. They will install and service equipment requested for each Customer 204 per the order received from the Customer 204 through the Facilitator 201. The Television Programming Providers 206 will set aside channel spectrum space so that they can run advertising supplied and scheduled by the Facilitator 201. The Television Program Providers 206 will install and maintain equipment that will allow the Customer 204 to review and respond to the interactive features of the advertising messages. (209, 210, 211>206) The Television Program Providers 206 will collect these messages using computer software supplied by the Facilitator 201 and give the data to the Facilitator 201 who will pass it on to the Advertiser 203. The Television Programming Providers 206 will contract with the various entities that produce and/or schedule television programs. The Programming 209, 210, 211 will be package in the same form that it is today by the various Television Programming Providers 206 and offered to the Customer 204 by the Facilitator 201.

5. A Variation in the Typical Relationship Structure

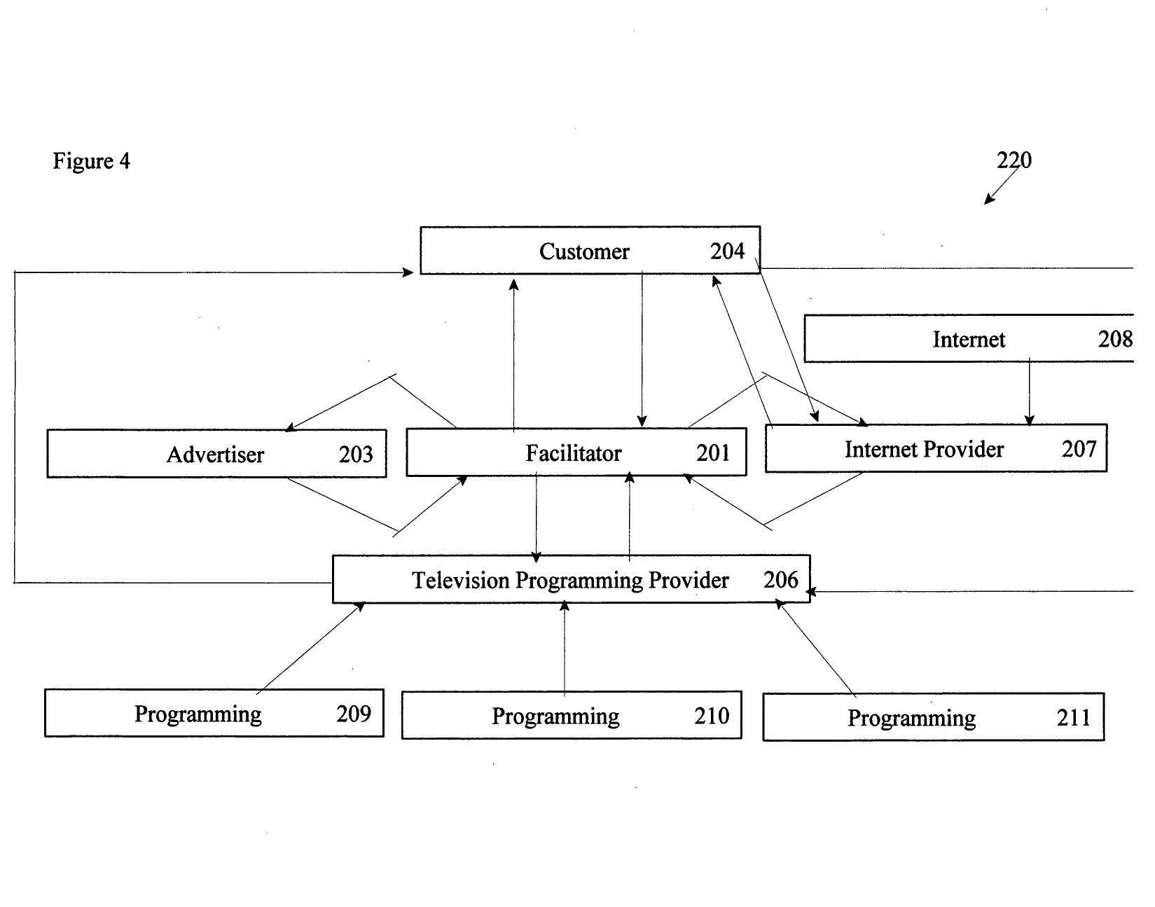

FIG. 4 is a schematic block diagram 220 that illustrates an approach for setting up an enterprise that contracts to offer media to customers according to an alternate embodiment described herein. The diagram 220 reveals an embodiment where the Customer 204 has an existing relationship with Programming Providers 102, referring but not limited to, the Television Programming Provider 206 and the Internet Provider 207. They might be allowed to continue that relationship under an embodiment. That continuation would be contingent upon their willingness to offer an embodiment described herein. If that stipulation is met, the Facilitator 201 would contract with the Television Programming Provider 206 and/or the Internet Provider 207 and the Customer 204. If any of the participants does not have a previous relationship with the Customer 204, they will be introduced and offered to the Customer 204 by the Facilitator 201 in accordance with an embodiment laid out herein. Should any Television Programming Provider 206 or Internet Provider 207 not wish to enter into a contracting relationship with the Facilitator 201, an alternate will be offered to the Customer 204. Should any Television Programming Provider 206 or Internet Provider 207 not be able to offer the services described in an embodiment, an alternate will be offered to the Customer 204. Should any Television Programming Provider 206 or Internet Provider 207 not be able to reach a financial arrangement agreeable to the Facilitator 201, an alternate will be offered to the Customer 204.

6. Dual Roles for the Facilitator

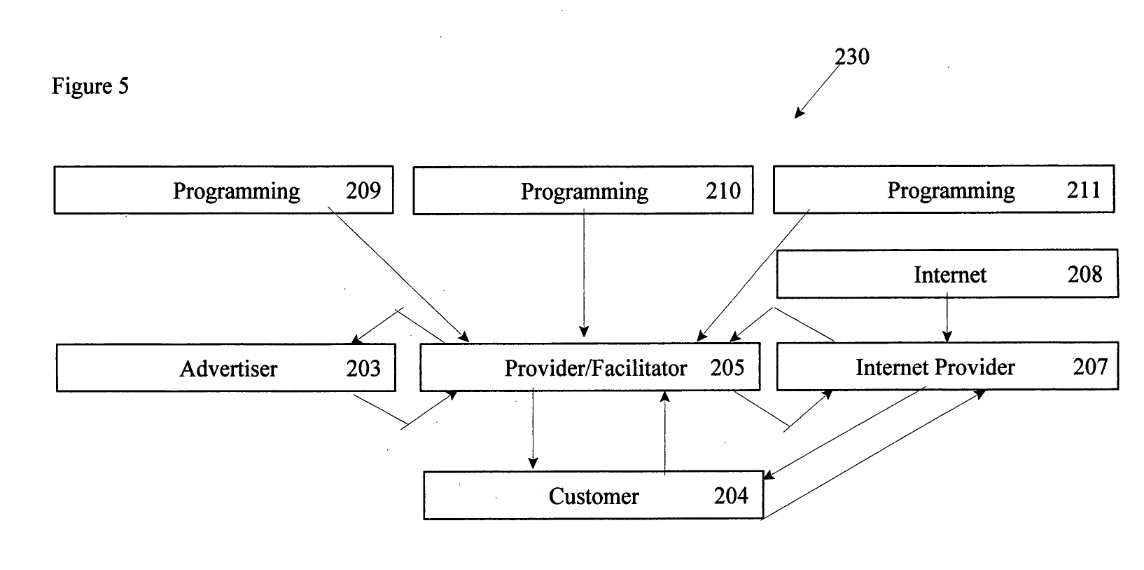

FIG. 5 is a schematic block diagram 230 that illustrates an approach for setting up an enterprise that contracts to offer media to customer according to an alternate embodiment described herein. The diagram 230 reveals an embodiment where the Facilitator 201 would perform the role as described herein but would also perform the role of Television Programming Provider 210 and/or the Internet Provider 207. The Facilitator 201 would become the Facilitator/Provider 205. (205>209, 210, 211) The Facilitator/Provider 205 would pursue contractual arrangements to secure access to the Programming 209, 210, 211 and/or the Internet 208 without limit as to the method of delivery.

In an embodiment, (205>203) the Facilitator/Provider 205 would offer a population of potential Customer 204 to the Advertiser 203 at a market price determined by the number and demographics of the Customer 204 profile that the Advertiser 203 wishes to reach. The Facilitator/Provider 205 captures information as to which Customers 204 were successfully reached, the results of the interactive communication and any other aspect of the received data. (203>205) The Facilitator/Provider 205 receives an order from the Advertiser 203 based on the number of Customers 204 that they wish to reach and the demographic specifications they want to target. The Advertiser 203 supplies the Facilitator/Provider 205 with the advertising content that the Advertiser 203 wants to run along with the interactive message that they want to deliver. The Advertiser 203 may elect to have the Facilitator/Provider 205 to produce the commercial content and/or the interactive message. The Advertiser 203 will pay the Facilitator/Provider 205 for the achieved results based on the contracted price.

In another feature of an embodiment, (205>204) the Facilitator/Provider 205 would solicit for Customers 204 who wish to engage a service that will provide them with a variety of media products and services potentially at no charge to them provided that they meet an interactive viewership requirement. The Facilitator/Provider 205 would collect demographic data in order to make a profile to give to the Advertiser 203. (204>205) The Customer 204 will contract with the Facilitator/Provider 205 to supply a selection of services from a menu. In an embodiment, the basic services would include, but not be limited to, the Programming 209, 210, 211 and the Internet 208. The Customer 204 would agree to pay a market price in currency for the product should they not meet the criteria of interactive viewership. The Customer 204 would agree to watch a designated number of minutes of interactive advertising that would be based on the number of menu options that they select. The Customer 204 will answer the interactive questions or provide other information requested. The Customer 204 would give the required demographic information to the Facilitator/Provider 205 that is deemed necessary to form a demographic profile to give to the Advertiser 203 as part of a general population of potential commercial targets.

Furthermore in an embodiment, (208>205) The Facilitator/Provider 205 would package and present to the Customer 204 access and a format for receiving the Worldwide Web through an Internet 208 system. (209, 210, 211>205) The Facilitator/Provider 205 would contract with the various entities that produce and/or schedule television programs. The Programming 209, 210, 211 would be packaged in the same form as it is with the Television Programming Provider 206 and offered to the Customer 204 by the Facilitator/Provider 205.

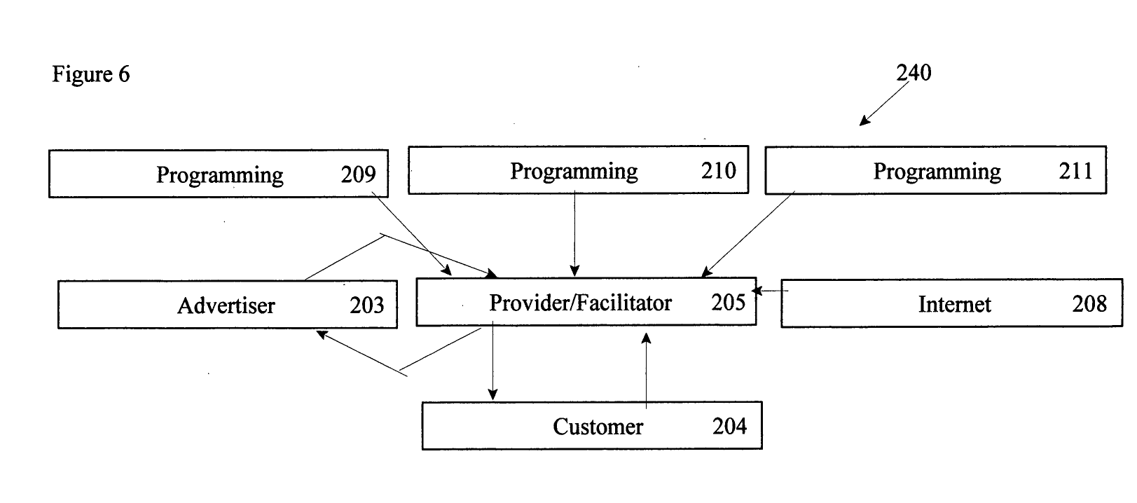

FIG. 6 is a schematic block diagram 240 that illustrates an approach for setting up an enterprise that contracts to offer media to customers according to an alternate embodiment described herein. The diagram 240 reveals an embodiment that is a variation of FIG. 5. It presents an embodiment where the Facilitator/Provider 205 performs the function of the Facilitator 201 and the Television Programming Provider 206 but not that of the Internet Provider 207. The Facilitator/Provider 205 would contract with the Internet Provider 207 in the same manner as FIG. 3 and FIG. 4.

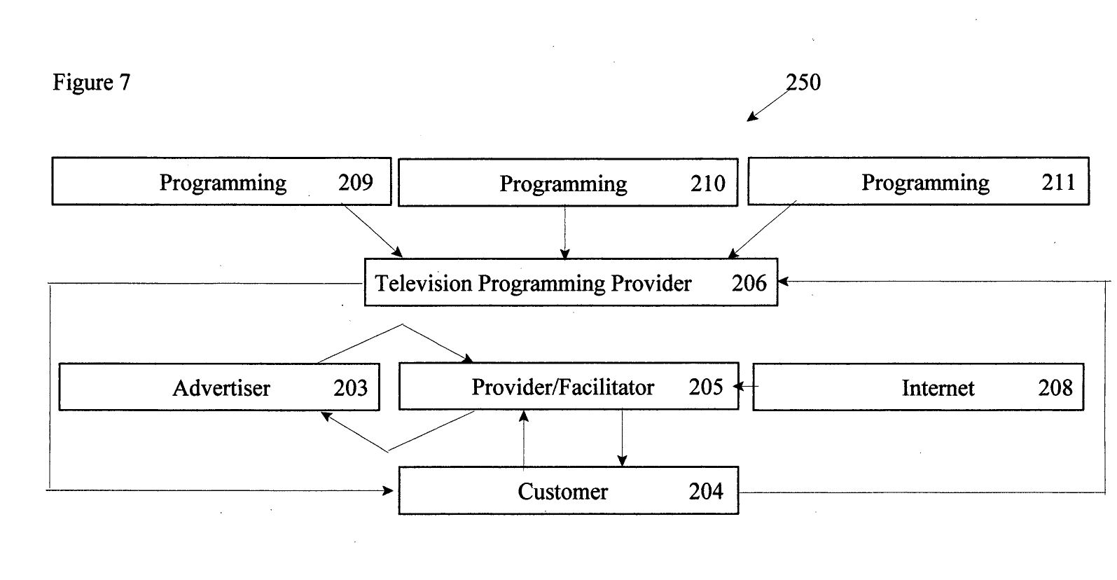

FIG. 7 is a schematic block diagram 250 that illustrates an approach for setting up an enterprise that contracts to offer media to customers according to an alternate embodiment described herein. The diagram 250 reveals an embodiment that is a variation of FIG. 5. It presents an embodiment where the Facilitator/Provider 205 performs the function of the Facilitator 201 and the Internet Provider 207 but not that of the Television Programming Provider 206, The Facilitator/Provider 205 would contract with the Television Programming Provider 206 in the same manner as FIG. 3 and FIG. 4.

7. Alternate Menu Options

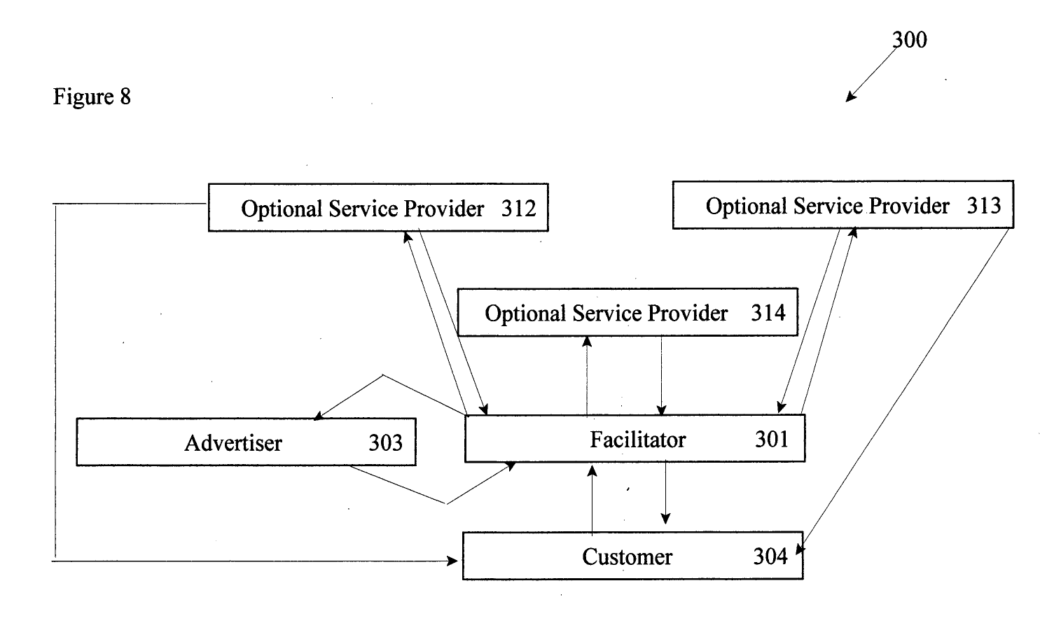

FIG. 8 is a schematic block diagram 300 that illustrates an approach for setting up an enterprise that contracts to offer media to customers according to one embodiment described herein. The diagram 300 reveals an embodiment that describes alternate Optional Service Providers 312, 313, 314 that are part of but not limited to a menu of services offered to the Customer 304. They are offered to the Customer 304 by the Facilitator 301 and paid for by the Advertiser 303 in exchange for watching a required amount of interactive advertising messages. Some of these services are, but are not limited to, streaming video, Internet banking, Internet gaming, land and cellular phone service, satellite radio, and Home Shopping. Since these services are not normally packaged, the Facilitator will contract with each Optional Service Provider 312, 313, 314 and then offer the services as a menu option to the Customer 304. The services will be offered at a market price and the Customer 304 would be responsible for the monetary cost of the various options or the equivalent in interactive commercial viewing minutes. The Advertiser 303 will compensate the Facilitator 301 based on the criteria requested. The Facilitator 301 would pay the Optional Service Provider 312, 313, 314 according to the costs negotiated.

In an embodiment, (301>303) the Facilitator 301 gives information retrieved from interactive advertising viewers by the Customer 304 along with a summary of demographic data. No specific Customer 304 information would be revealed except at the Customer's 304 request. (303>301) The Advertiser 303 would produce a commercial message along with an information request to satisfy the interactive element of the ad. The Advertiser 303 would specify to the Facilitator 301 the demographic representation that they wanted to reach and the total number of consumer households they wanted to receive the message. The Advertiser 303 would compensate the Facilitator 301 for the results based on an agreed upon price. The price would vary by the demographics sought, the nature of the interactive data that is received, and the amount of time viewed.

To continue an embodiment, (301>304) the Facilitator 301 would offer services as the Provider 102 to the Customer 104. The Facilitator 301 would collect and package the service elements requested by the Customer 304 from a media menu. The Facilitator 301 would deliver to the Television Programming Provider 206 or the Internet Provider 207 as described in a previous embodiment. The Facilitator 301 would collect the advertising content and interactive message supplied by the Advertiser 303. (304>301) The Customer 304 would contract with the Facilitator 301 for the services that they wish to receive. The parties would agree to pay a market price. In Lieu of the monetary price, the Customer 304 would agree to view a specified amount of interactive advertising. The Customer 304 would input the information requested by the interactive message to be collected by the Facilitator 301. The Customer 304 would give the Facilitator 301 demographic data on a confidential basis to provide the Advertiser 303 with a choice of recipients to satisfy their need.

Furthermore, an embodiment (312, 313, 314>301) would have the Facilitator 301 make independent arrangements with the Optional Service Providers 312, 313, 314 who provide their services commercially. The Facilitator 301 would package those services into menu options for the Customer 304. The Facilitator 301 would pay the Optional Service Providers 312, 313, 314 out of the revenue generated from the Advertisers 303 as a result of the interactive advertising viewed by the Customer 304.

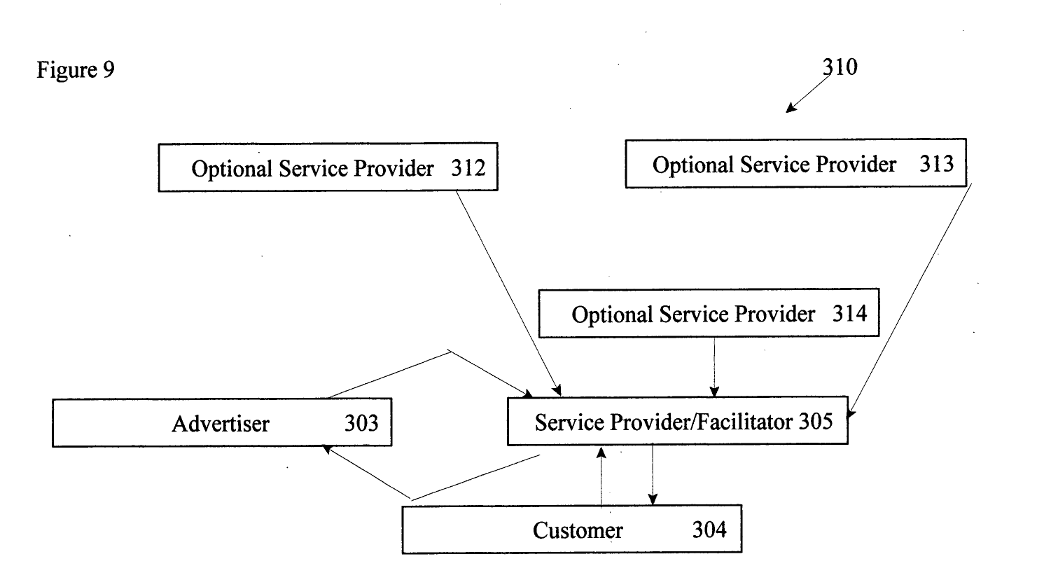

FIG. 9 is a schematic block diagram 310 that illustrates an approach for setting up an enterprise that contracts to offer media to customers according to an alternate embodiment described herein. The diagram 310 reveals an operation that is the same in every way to FIG. 8 in terms of the relationship described. The difference is that the Television Programming Providers 206, Programming 209, 210, 211, Internet Provider 207 and Internet 208, as illustrated in FIGS. 5, 6, and 7, relate to the Facilitator/Provider in the same manner as an embodiment described herein.

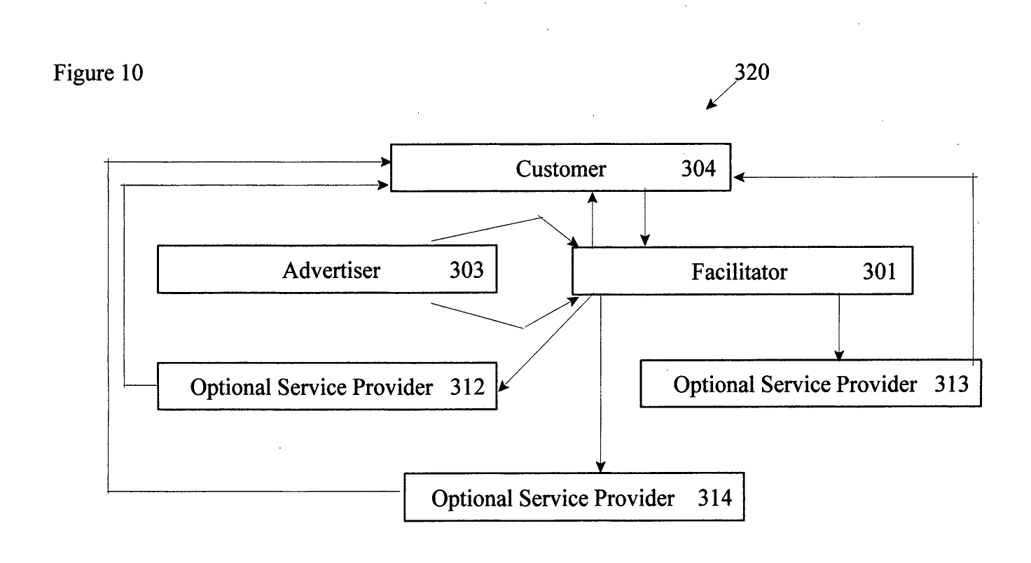

FIG. 10 is a schematic block diagram 320 that illustrates an approach for setting up an enterprise that contracts to offer media to customers according to an alternate embodiment described herein. The diagram 320 reveals an operation that is the same in every way to FIG. 9 in terms of the relationships described except that the Customer 304 is already receiving one or more of the services from the Optional Service Providers 312, 313, 314. In an embodiment, the Customer 304 might be allowed to continue the relationship with the Optional Service Provider 312, 313, 314. That continuation would be contingent upon the Optional Service Providers' 312, 313, 314 willingness to join the program. If that stipulation is met, the Facilitator 301 would contract with the Optional Service Provider 312, 313, 314 and the Customer 304. If any of the participants does not have a previous relationship with the Customer 304, they would be introduced and offered to the Customer 304 by the Facilitator 301 in accordance with the program. Should any Optional Service Provider 312, 313, 314 not with to enter into a contractual relationship with the Facilitator 301, an alternate would be offered to the Customer 304. Should any Optional Service Provider 312, 313, 314 not be able to offer their services in accordance with process as described in an embodiment, an alternate will be offered to the Customer 304. Should any Optional Service Provider 312, 313, 314 not be able to reach a financial arrangement agreeable to the Facilitator 301, an alternate would be offered to the Customer 304.

8. Information Menu Option

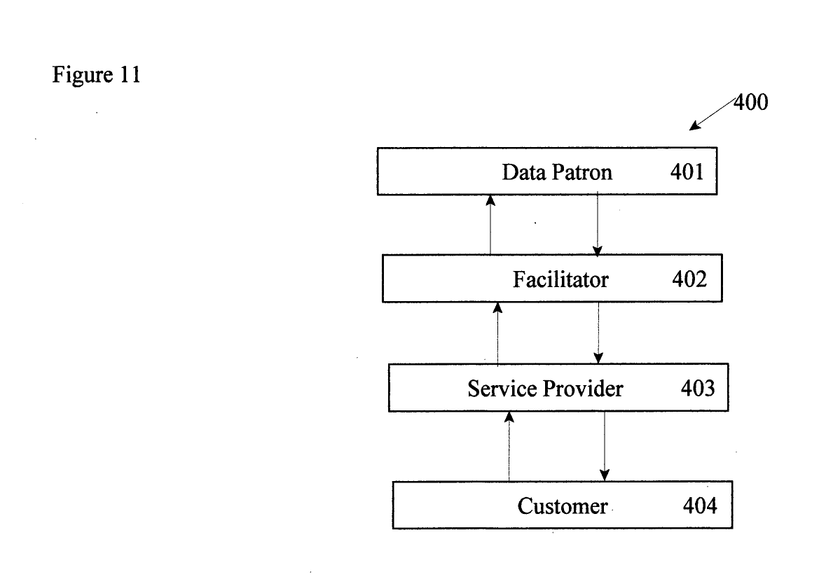

FIG. 11 is a schematic block diagram 400 that illustrates an approach for setting up an enterprise that contracts to solicit information from customer according to one embodiment described herein. The diagram 400 reveals an operation that collects information for the benefit of, but not limited to, those who are involved in the political arena, the television industry, academia, and the government. The Facilitator 402 would receive the order and content of an inquiry from a Data Patron 401. The Data Patron 401 would select the sample of demographics. The Facilitator 402 would pass the package of content on to the Provider 403 who would schedule and run the interactive content to the Customer 404. The Customer 404 would supply the requested information through the interactive system back to the Provider 403 who would give the collected data to the Facilitator 402. In turn, the requested information would be given to the Data Patron 401 along with a demographic summary. The Data Patron 401 would pay the Facilitator 402 according to agreed upon terms. The Facilitator 402 would give credit to the Customer 404 and pay the Provider 403 for the services on behalf of the Customer 404. This embodiment would operate in all embodiments described herein.

9. Advertising Steps

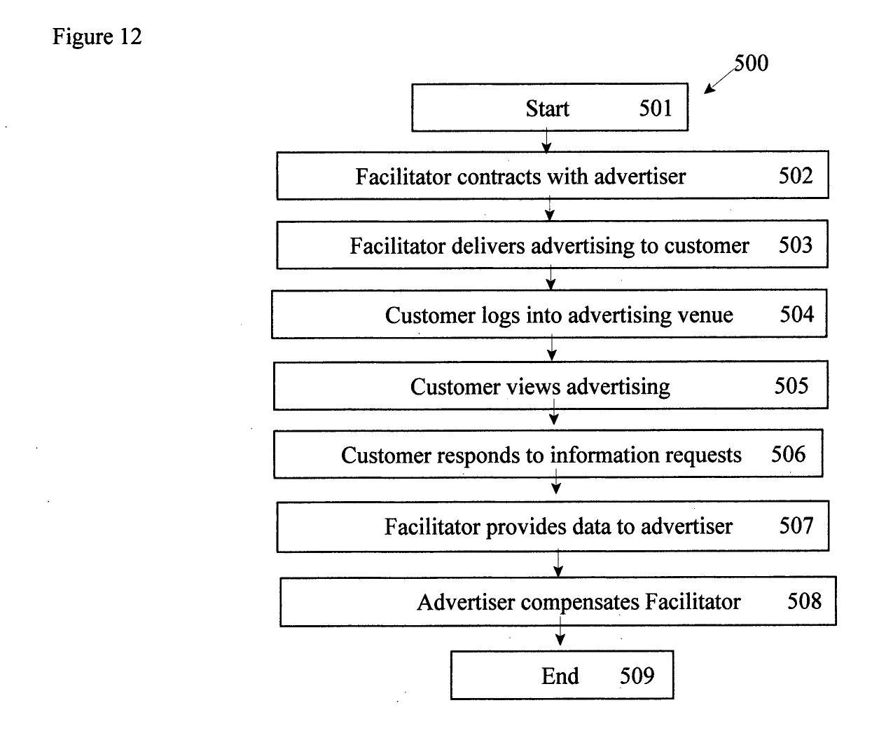

FIG. 12 is a flow chart 500 that illustrates a segment of an approach for setting up an enterprise that contracts to offer media to customers according to one embodiment described herein. The diagram 500 reveals the segment of an operation that begins with the solicitation of Advertisers to produce and pay the Facilitator for interactive advertising on appropriate media outlet by the Provider 501. 502. The Facilitator contracts with various Advertisers that seek to have the public view their message regarding their products or services. The Advertiser produces a commercial advertising message with interactive request for information in the body of the commercial or as a tag at the end. 503. The Advertiser selects a demographic that they wish to reach. The Facilitator instructs the Television Programming Provider or the Internet Provider to run the Advertiser's message on a designated channel or web site. The Facilitator would choose the channel or web site based on demographic data collected from the Customer. 505. The Customer is instructed as to which channel or web site they are to tune in and view to receive credit toward the costs of their selected media package. The Customer should enter their PIN number or provide some other verification of their identity. The Customer would view the advertising message. 506. The customer responds to the interactive information request. If the information is correct, the Customer is notified as to the credit received. 507. The data is collected on software that the Facilitator has supplied to the Provider. The Provider gives the information to the Facilitator. The Facilitator compiles the data, summarizes it and gives it to the Advertiser. 508. The Advertiser compensates the Facilitator according to a contractual agreement. The Facilitator distributes the funds to itself and the Providers on behalf of the Customer. 509. An embodiment of this segment of the process is completed.

10. Steps for Receiving Service

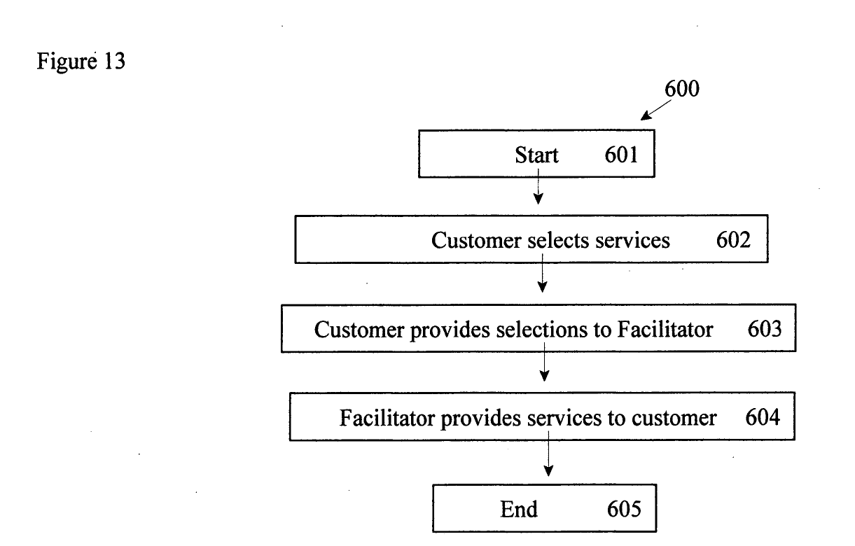

FIG. 13 is a flow chart 600 that illustrates a segment of an approach for setting up an enterprise that contracts to offer media to customers according to one embodiment described herein. The diagram 600 reveals the segment of an operation for delivering media services to the Customer. 601. The agreement states that the Customer will be responsible for the market cost of the services or the equivalent in interactive minutes of commercial viewing. 602. The Facilitator offers a selection of media menu options to the Customer. The Customer makes a selection that suits them but includes a method to receive the interactive advertising. 603. The Customer contracts with the Facilitator for the specific menu items to be received. The Facilitator makes arrangement with the various Providers responsible for the chosen services. The services are delivered to the household from a variety of means as deemed appropriate for the Customer by the Facilitator. 605. An embodiment of this segment of the process is completed.

11. Steps for Contracting with Providers

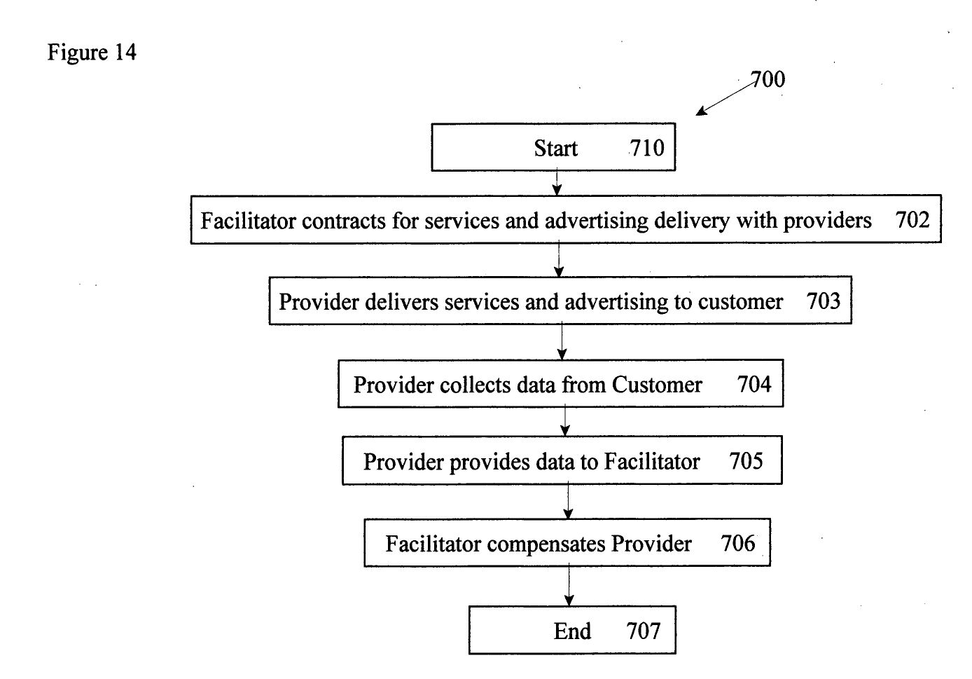

FIG. 14 is a flow chart 700 that illustrates a segment of an approach for setting up an enterprise that contracts to offer media to customers according to one embodiment described herein. The diagram 700 reveals the segment of an operation that contracts with Providers. 701. The Customer selects services from the media menu. 702. The Facilitator would contract with the Provider that the Facilitator has a relationship with. The Facilitator would negotiate a price with the Provider to service the household and to deliver the advertising message along with the interactive portion of the commercial. The Provider would agree to dedicate television channels or Internet sites for the viewing of the interactive advertising. 703. The Provider delivers the services as they would with any of their existing Customers. The Provider would run the advertising and the interactive message on the channels or sites according to the direction of the Facilitator. 704 The Facilitator would supply the Provider with software to collect and sort the data from the interactive responses. The Provider would collect that data from the Customer. 705. The Provider would give the data to the Facilitator. 706. The facilitator would compensate the Provider for the service to the Customer, the channels or sites and the collection of the data out of the proceeds from the Advertisers. An embodiment of this segment of the process is completed.

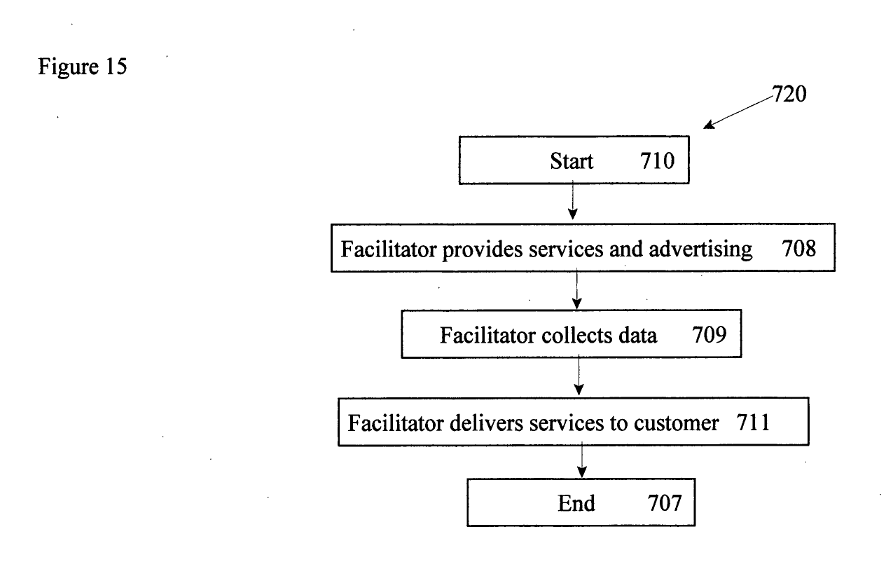

FIG. 15 is a flow chart 720 that illustrates a segment of an approach for setting up an enterprise that contracts to offer media to customers according to an alternate embodiment described herein. The diagram 720 reveals the segment of an operation that describes the Facilitator as the Provider. 701. The Facilitator would contract with the Customer. The Facilitator would deliver the menu of media selected by the Customer along with channels and web sites for viewing the interactive advertising. The delivery can take place by any available means including but not limited to cable, airwaves, broadband and satellite. 709. The Customer would enter their PIN number or other identifier when viewing the interactive advertising. They would view the advertising on a television channel or Internet site that had been selected for their demographic. The Facilitator would record their responses and the minutes viewed on software. The data would be summarized so the Facilitator could validate the order from the Advertiser who would compensate the Facilitator based on the results. 710. The Facilitator would continue to provide services to the Customer as long as they keep current on their monetary or interactive viewing obligation. 707. This segment of an embodiment is completed.

12. Steps for Customers with Existing Services

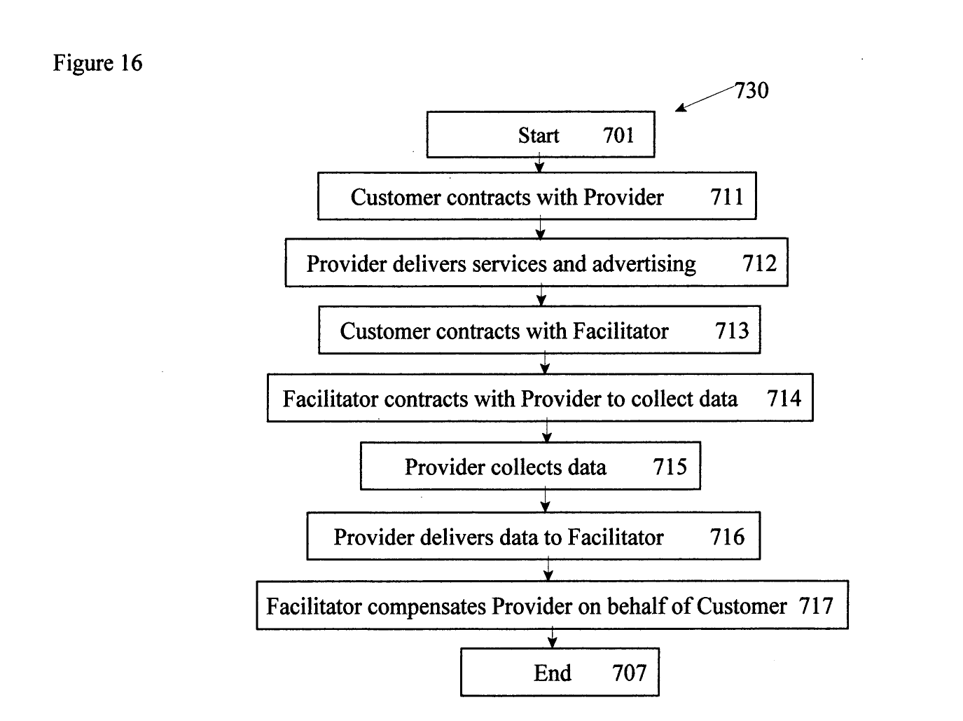

FIG. 16 is a flow chart 730 that illustrates a segment of an approach for setting up an enterprise that contracts to offer media to customers according to an alternate embodiment described herein. The diagram 730 reveals the segment of an operation when the Customer has already contracted with one of the Providers to receive one of the services. 701. The Customer is interested in receiving one of the media services, 711. The Customer contracts with a Provider on their own to receive the service. 712. The Provider begins and maintains the designated services to the Customer. 713 The Customer becomes aware of the advantage of joining and receiving the services of the Facilitator's organization. The Customer expresses a wish to contract to do business with the Facilitator. The Facilitator makes contact with the Provider on behalf of the Customer to establish a relationship as the agent for the Customer for the same terms of the Customers current contract. 714. The Facilitator contract with the Provider, if they deliver television or Internet service, to set aside channels or sites for the interactive commercial advertising. The Facilitator supplies the Provider with the advertising and the software to collect the viewing and interactive response information. 715. The Provider agrees to collect the data. 716. The Provider then collect and delivers the data to the Facilitator. 717. The Facilitator compensates the Provider for the advertising television channels or Internet sites (if applicable), the collection of the data, and the service on behalf of the Customer. 707. This segment of an embodiment is completed.

12. Steps for Contracting with a Data Patron

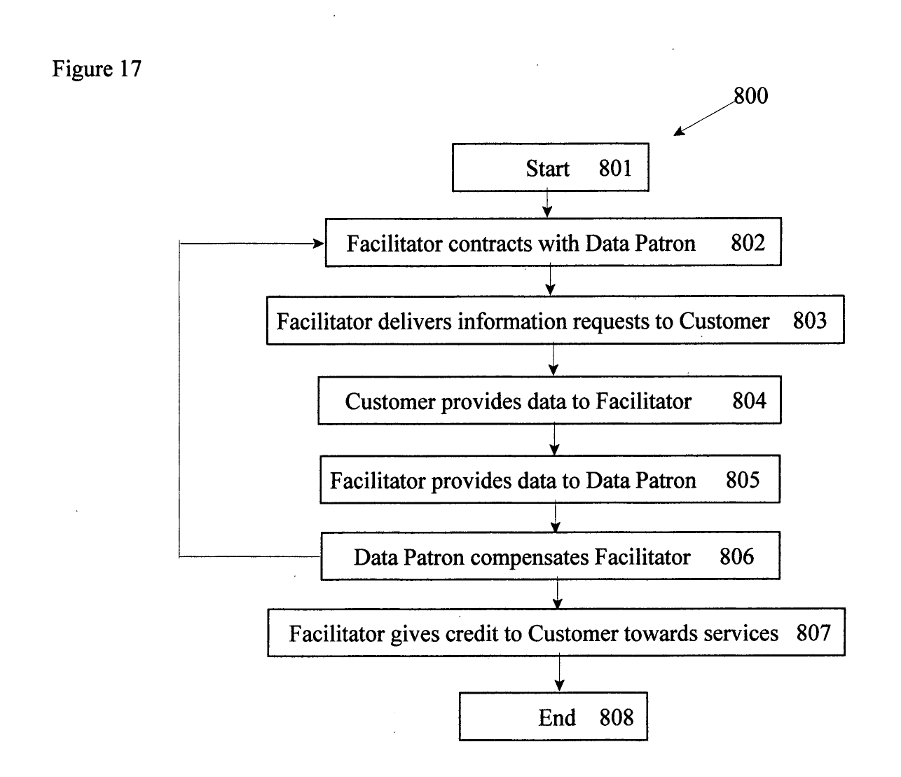

FIG. 17 is a flow chart 800 that illustrates a segment of an approach for setting up an enterprise that contracts to offer media to customers according to an embodiment described herein. The diagram 800 reveals the segment of an operation when a Data Patron wants to solicit data from the Facilitator's population of Customers. Examples of Data Patrons include but are not limited to political entities, segments of the government, academic studies, the entertainment industry, and providers of products and services. 801. Interested Data Patrons would want to get opinion data from the public. 802. They would contract with the Facilitator to get the information through a questionnaire that they would supply. 803. The Facilitator would use existing Providers to transmit the information requests over dedicated television channels or Internet sites to the Customers included in the demographic selected by the Data Patron. The Customer would be offered credit toward their billing obligation. 804. The Customer would make the responses which would be collected on the software supplied to the Provider by the Facilitator. The Provider would pass the collected data to the Facilitator. 805. The Facilitator would give the compiled data to the Data Patron. 806. The Data Patron would compensate the Facilitator based on the demographics requested by the Data Patron. 807. The Facilitator would credit the account of the Customer toward their billing obligation. 808. This would complete this segment of an embodiment.

13. Steps for Implementing an Embodiment of the Invention

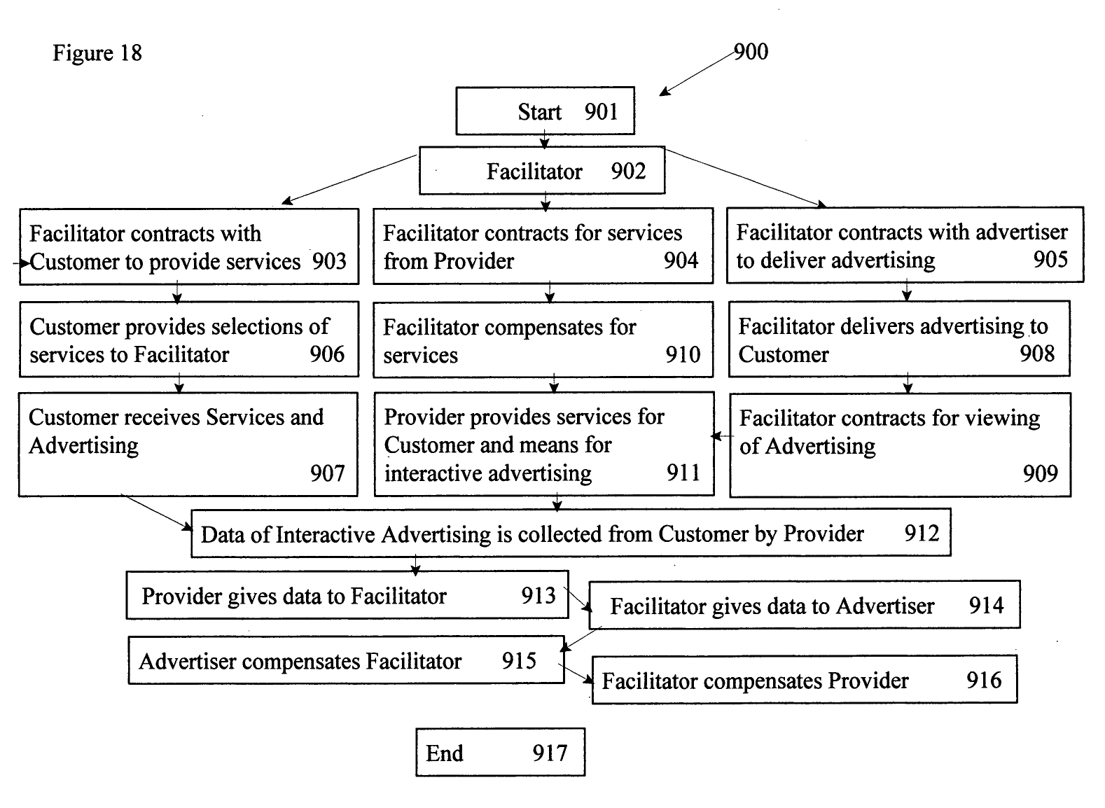

FIG. 18 is a flow chart 900 that illustrates an approach for setting up an enterprise that contracts to offer media to customers according to an embodiment described herein. The diagram 900 reveals an overview of the process. 901. The inventor creates the Facilitator organization or combines with another organization to create the Facilitator. 902. The Facilitator sets up to contract with the elements of the business which include but are not limited to the Customers, the Providers and the Advertisers. 903. The Facilitator contracts with the Customers to receive media services at no out of pocket cost if they meet an interactive advertising viewing requirement equivalent to the cost placed on the services by the Facilitator and the value of the interactive viewing placed on it by the Facilitator. 904. The Facilitator contracts with the Providers who deliver media services to the public. 905. The Facilitator contracts with businesses who wish to have an advertising message seen by members of the public. 906. The Customer selects the media services that they wish to receive. The Customer agrees to pay the monetary cost of these services. They are given a PIN number for each member of their household who belong to a potential demographic that Advertisers wish to reach. The Customer would enter the PIN number each time they viewed the interactive advertising. Other modes of verification might also be required. Each time the Customer views an advertising message, a credit goes towards their billing statement so that they have the potential to receive their menu of services at no monetary cost. 907. The Facilitator arranges for the Provider to deliver the services to the Customer. The Providers would deliver the interactive advertising messages to the Customers via dedicated television channels or Internet sites. The Provider would supply a receiver, the necessary connections, and the installation of equipment needed to receive those services and comply with the interactive aspect of the process. Examples would be but are not limited to remote control devices to operate the television options, the Internet and the options on the interactive channels. 908. The Facilitator arranges with the Advertiser to supply a produced commercial message and the interactive information request that would be part of the body of the advertising message or a tag on the end. The Advertiser might elect to have the Facilitator produce and supply the commercial and interactive request. 909. The Facilitator would supply the software to collect the Customer responses and viewing credit. The facilitator would arrange compensation agreements with the Providers for the service to the Customer, the television channels, and Internet sites designated to run the commercials, the interactive messages, and the retrieval of the data on behalf of the Facilitator. 911. The Providers would supply their services to the Customer based on orders from the Facilitator. They would supply the equipment. They would maintain the system. They would deliver the advertising and interactive requests. The Provider would receive and compile the data from the Customer using software supplied by the Facilitator. They would do this over dedicated television channels and Internet sites. 912. The Provider would collect the answers to information requests in the interactive messages along with the viewing time to be credited to the Customer. They would use the software supplied by the Facilitator. 913. The Provider would give the collected data in the form designed into the software by the Facilitator. 914. The Facilitator would give the data to the Advertiser to verify the viewership and the demographics requested. 915. The Advertiser compensated the Facilitator based on the contracted price for the contracted demographic population. 916. The Facilitator distributes the funds according to the profit model that they set up. The Facilitator compensates the Provider for the cost of the services per their negotiated contract. 917. This would complete one embodiment.

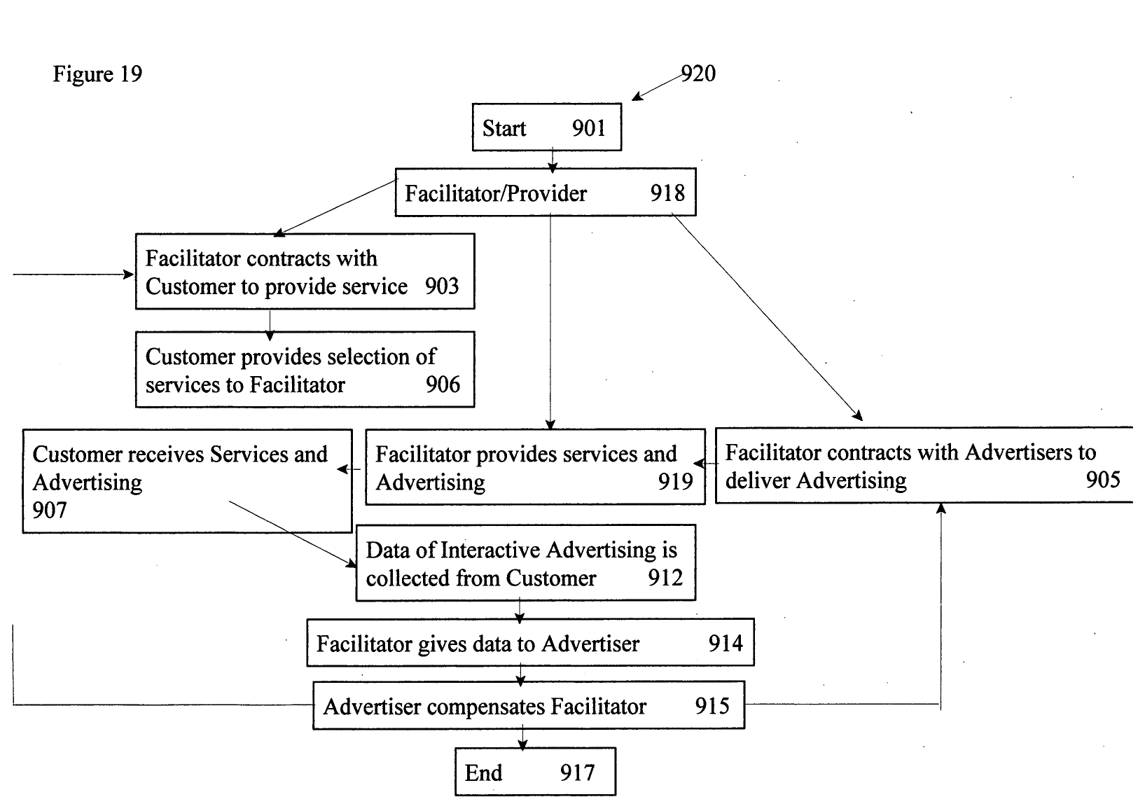

FIG. 19 is a flow chart 920 that illustrates an approach for setting up an enterprise that contracts to offer media to customers according to an alternate embodiment described herein. The diagram 920 reveals an overview of the process. 901. In an embodiment, the inventor creates the Facilitator/Provider organization or combines with another organization to create the Facilitator/Provider. The Facilitator/Provider would be the Provider for one or more of the media selections. If the Facilitator/Provider did not supply the television and/or Internet service, the process would be closer to FIG. 18. 918. The Facilitator/Provider sets up to contract with the elements of the business which include but are not limited to the Customer, other Providers, the Television Programming, the Internet, and Optional Service Providers. 903. The Facilitator/Provider contracts with Customers to receive media services at no out of pocket costs if they meet an interactive advertisement viewing requirement equivalent to the cost placed on those services by the Facilitator/Provider and the value of the interactive viewing placed on it by the Facilitator/Provider. 906. The Customer selects the media services that they wish to receive. The Customer agrees to pay the monetary cost of those services. They are given a PIN number for each member of the household who belongs to a potential demographic that Advertisers wish to reach. The Customer would enter the PIN number each time they viewed the interactive advertising. Other modes of verification might also be required. Each time the Customer views an advertising message, a credit goes towards their billing statement so that they have the potential to receive their menu of services at no monetary cost. 907. The Facilitator/Provider arranges for their portion of the media services and those of other Providers to be delivered to the Customer. The Facilitator/Provider or other Provider would deliver the interactive advertising message to the Customer via dedicated television channels or the Internet sites. The Facilitator/Provider or Provider would supply a receiver, the necessary connections, and the installation of equipment needed to receive the services and comply with the interactive aspects of the process. Examples of these items would be, but are not limited to, remote control devices to operate the television options, the Internet, and the options on the interactive channels. 919. The Facilitator/Provider contracts and arranges with the Advertiser to supply a commercial message that they have produced along with the interactive information request either as part of the body of the message or a tag at the end. The Advertiser could elect to have the Facilitator/Provider produce the advertising and message. 918. The Facilitator/Provider would supply their service to the Customer based on their contracted order. The Facilitator/Provider would supply the equipment to the Customer. They would maintain the system. They would deliver the advertising and interactive request. The Facilitator/Provider would receive and compile the data from the Customer using appropriate software. They would do this over dedicated television channels and Internet sites. 912. The Facilitator/Provider would collect the requested responses from the interactive messages along with the viewing time to be credited to the Customer on appropriate software. 914. The Facilitator/Provider would give the data to the Advertiser to verify the viewership and the demographic requested. 915. The Advertiser compensates the Facilitator/Provider based on the contracted price for the contracted demographic population. 916. The Facilitator/Provider compensates the other Providers from the cost of the services per their negotiated contract. 917. This would complete an alternate embodiment.

14. Compensation

The Facilitator would negotiate with the Providers for a price to deliver and maintain their services to the Customer. The Facilitator would negotiate with the Customer for a price to arrange the delivery and maintenance of the Provider's services to the Customer. The Facilitator would negotiate a cost to the Advertiser for the viewing of interactive advertising by the Facilitator's Customers based on but not limited to the Customer's demographics, the minutes watched, and the type of information requested by the Advertiser. The Facilitator would be paid upon delivery of a summary of the data to the Advertiser. The Facilitator would collect and distribute all funds according to their profit model. The Customer would receive credit for their interactive viewing minutes or pay the contracted price.

15. Interactive Response Equipment

The Facilitator would choose equipment that would allow the Customer to receive and respond to the interactive information requests. Examples of this equipment could be but are not limited to a cordless computer key pad, a connected computer key pad, and a television remote control. These devices would have to have the capacity to manipulate and choose options over the Internet and over phone lines connected to a television signal receiver box.

16. Verification

The Facilitator will give each person in a household a PIN number if they are members of a demographic that the Advertisers might potentially be interested in. The Customer would enter this PIN number each time they viewed the advertising message they were directed by the Facilitator to watch and answered interactive questions. This would enable the Customer to get credit for their viewership. Other methods for verification would include but are not limited to random phone calls during the advertisement viewing, Internet web cameras, and fingerprint identification.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A means for creating a facilitator organization for delivering a menu of media and computer options potentially at no cost to consumers in exchange for viewing interactive advertisements comprising the steps of:
A means of offering said media and Internet services to the consumer;
A means of offering said interactive advertising to the commercial advertisers;
A means of offering said interactive advertising to the consumers;
A means of collecting and distributing revenue generated by said advertising, said Internet services and said media services;
A means of offering a single entity for said media and said Internet services to the consumer;
A means of offering a single entity to the commercial advertiser to contract for said services;
A means of creating said facilitator organization;
A means by which said facilitator offers said media and Internet services to the consumer potentially at no financial cost;
A means by which said facilitator offers said media and Internet services to the consumer in exchange for viewing interactive advertising via the Internet;
A means by which said facilitator offers said media and Internet services to the consumer in exchange for viewing interactive advertising on television;
A means by which said facilitator will ask questions regarding the advertising on behalf of the advertiser;
A means by which said facilitator will receive data as a result of the consumers answers;
A means by which said facilitator will receive data via the Internet or telephone connection;
A means by which said facilitator will operate a series of Internet sites that will provide a selection of advertising messages and related interactive questions;
A means by which said facilitator will contract with program providers to secure dial settings that will show a selection of advertising messages and related interactive questions;
A means by which said facilitator will provide the consumer with a wireless Internet keyboard;
A means by which said facilitator will provide the consumer with a remote control that operates interactively with a program providers receiver;
A means by which said facilitator will contract with the consumer to provide a menu of services;
A means by which said facilitator will contract with the advertiser to provide commercial messages and interactive data from the consumer;
A means by which said facilitator will contract with program providers to continue service or install service via satellite, cable or broadband;
A means by which said facilitator will contract with Internet service providers to continue service or install service via satellite, cable or broadband;
A means by which said facilitator may contract with individual programming providers to deliver content directly to the consumer via satellite, cable or broadband;
A means by which said facilitator will provide the consumer with a billing statement that will include the monetary cost of their selected services;
A means by which said facilitator will provide the consumer with a billing statement that will include the number of interactive advertising minutes required to eliminate the financial cost;
A means by which said facilitator will give the consumer a pin number to be entered each time they view the interactive advertising;
A means by which said facilitator will give credit towards their service bill each time they provide the requested information;
A means by which said facilitator will give each person in the household a separate pin number;
A means by which said facilitator will credit the household account depending on the demographic requested by the advertiser;
A means by which said facilitator will determine the value of the demographic in minutes credited to the household;
A means by which said facilitator will charge the advertiser depending on the number of households demographic requested;
A means by which said facilitator will run advertising on channel settings and Internet sites according to demographic categories;
A means by which said facilitator will collect appropriate data to give to the advertiser to determine the effectiveness of their exposure; and
A means by which said facilitator will keep a confidential database of demographic categories in each subscribing household.
